(19) United States
(12) Patent Application Publication
(10) Pub. No.: US 2014/0281640 A1
(43) Pub. Date: Sep. 18, 2014

(54) INTELLIGENT FRONT PANEL

(71) Applicant: Silicon Graphics International Corp., Milpitas, CA (US)

(72) Inventor: Jay Everett Nelson, Superior, CO (US)

(73) Assignee: Silicon Graphics International Corp., Milpitas, CA (US)

(21) Appl. No.: 13/831,657

(22) Filed: Mar. 15, 2013

(51) Int. Cl. G06F 1/26

(52) U.S. Cl. CPC G06F 1/26
USPC 713/330

(57) ABSTRACT

The front panel includes intelligence for controlling power, reset and power down functions for a storage enclosure having multiple servers, service processors, and enclosure management devices. The front panel may display information pertaining to system power state, disk activity, Ethernet activity, and other information. The front panel may implement sequencing rules for changes in power state. The front panel provides information for multiple servers and other devices through a single panel.

### BACKGROUND OF THE INVENTION

1. Field of the Invention

The present invention relates to front panels of storage enclosures. In particular, the present invention relates to intelligent front panels for storage enclosures with multiple servers.

2. Description of the Related Art

As companies use more and more data, the need for larger data storage systems has increased. As such, data storage enclosures are expanding to meet this increasing need.

Typically, a data storage enclosure includes a single server within the enclosure. A front panel is typically provided at the front of the enclosure to monitor the server. As additional servers are added, they each require a separate front panel to be added to the front of the storage enclosure. This additional front panel provides for a crowded space on the front of the enclosure very quickly, and eventually becomes impossible to implement for large numbers of servers. Other components, such as processors and other circuitry within the enclosure, may also require additional control and display information and is typically not provided by front panels of the prior art.

What is needed is an intelligent front panel that may handle multiple servers and other components and provide necessary power sequencing for these components.

### SUMMARY OF THE CLAIMED INVENTION

The front panel of the present invention includes intelligence for controlling power, reset and power down functions for a storage enclosure having multiple servers, service processors, and enclosure management devices. The front panel may display information pertaining to system power state, disk activity, Ethernet activity, and other information. The front panel may implement sequencing rules for changes in power state. The front panel provides information for multiple servers and other devices through a single panel.

An embodiment may include a storage enclosure including a single front panel, a first processor, a set of hard disks, a plurality of servers, and a power supply unit. The single front panel configured to manage a sequence of power control events using the power supply unit for the plurality of servers, hard disks, and first processor.

An embodiment may manage a power sequence using a front panel of a storage enclosure by first detecting a configuration of the storage enclosure. Input may be received to perform a power-on sequence. A power on signal may be provided to a power supply unit. A chassis ready signal may be provided from a first processor. The first processor may send the chassis ready signal in response to receiving ready signals from a plurality of hard drives and port expander units. Power may be provided to one or more servers within the storage enclosure by the front panel.

### BRIEF DESCRIPTION OF THE DRAWINGS

FIG. 1 is a block diagram of a storage enclosure.

FIG. 2 is a block diagram of the exterior of a front panel.

FIG. 3 is a flow chart of a method for performing an initial power on sequence.

FIG. 4 is a flowchart illustrating a method for performing a power on sequence of enclosure servers.

FIG. 5 is a flowchart of a method for performing a power on sequence for enclosure elements other than servers.

FIG. 6 is a flowchart of a method for performing a power down sequence for an enclosure.

### DETAILED DESCRIPTION

The front panel of the present invention includes intelligence for controlling power, reset and power down functions for a storage enclosure having multiple servers, service processors, and enclosure management devices. The front panel may display information pertaining to system power state, disk activity, Ethernet activity, and other information. The front panel may implement sequencing rules for changes in power state. The front panel provides information for multiple servers and other devices through a single panel.

FIG. 1 is a block diagram of a storage enclosure. The storage enclosure 100 of FIG. 1 includes front panel 110, service processors 120, server A 130, server B 140, fans 150, disc SAS expander 165, hard disk drives 165 and power supply unit 170. Front panel 110 may communicate with power supply unit 170 and enclosure components 120-165. Front panel 110 may include a processor 112 and panel display elements 114. Processor 112 may be implemented as a microprocessor which executes intelligence and logic for handling front panel operations such as power sequences, communications with other components, and other functions. Processor 112 may be implemented as any microprocessor or other processor, for example such as a programmable system on a chip by “Cyprus semiconductor.” Panel display elements 114 of front panel 110 may include LEDs, and LCD, selectable and depressible buttons, and other elements.

Service processor 120 includes one or more processors that may manage storage enclosure devices. In some embodiments, the service processors may communicate with and manage communications and access to portions of hard disks 165. Servers A (130) and B (140) may communicate with outside devices and provide access to hard disks 165 and other components to outside resources, such as over a network in communication with storage enclosure 100.

Power supply unit 170 may receive power from an outside source, such as a connection to an AC source, and provide power to the components of storage enclosure 100, such as fans 150 and other components. The SAS expander module 160 may communicate with and control hard disk drives 165. Hard disk drives may include disk storage elements and other storage components for storing data. SAS expander 160 may include one or more SAS port expanders which relay information to and from service processors 120. In some embodiments, processor 112 of front panel 110 may also communicate with the SAS port expanders.

FIG. 2 is a block diagram of a front panel. Front panel 200 includes a module selection and control portion having elements 210-224, module LEDs which consists of elements 240-262, and LDC character display 230.

The module selection and control portion includes selectable buttons 210-216. The selectable buttons include select button 210, power button 212, reset button 214, and non-maskable interrupt button 216. The select button allows a user to select between one of the several components listed on the front of panel display 200. In the embodiment illustrated, the selectable components include (and are represented by an LED) compute unit A 220, compute unit B 222, and service processor 224. A front panel 200 may include LEDs representing other components that may be selected on the front of the front panel using the select button 210.

Power button 212 may be used to initiate power sequencing for the enclosure. For example, holding down the power button for different periods of time may initiate different power sequences. A user may hold down the power button for a first period of time, which initiates a power sequence for all systems. The power sequence for all systems may apply power to compute units, the service processor, and servers. The period of time may be ten seconds or more. In other embodiments, a brief push of the power button 212 may initiate a power sequence for just the compute engines and service processor.

The reset button 214 may reset power for one of the components selected through use of selection button 210. The non-maskable interrupt button 216 may interrupt and stop the processing currently occurring in one of the components selected through selection button 210.

The module LEDs indicates information for several components of the enclosure. For example, for service processor 240, LEDs are provided for power, HDD, status, and Ethernet activity. The power LED indicates whether the service processor is currently receiving power, the hard disk drive LED indicates if the hard disk drives associated with the service processor are operating, the status LED indicates the health of the service processor, and the Ethernet LED indicates if the service processor has an Ethernet connection. Compute engine A and compute engine B 250 and 260 each also include corresponding LEDs for their power, hard disk drive status, health status, and Ethernet connection status.

FIG. 3 is a flow chart of a method for performing an initial power on sequence. First, AC power is applied to the storage enclosure at step 310. Applying AC power to the storage enclosure may involve plugging the enclosure in. Next, initial power on is performed to field replaceable units within the enclosure at step 320. The initial power on may be applied to server processors, fans, hard disks and other devices. The initial power on may provide a power of 5 volts DC to the front panel, service processors, SAS port expanders, the disks, fans, and other FRUs. After the initial power up, devices may complete a boot process and POST routine. The front panel may then drive LEDs for the service processor, and any other components which are activated during the initial power on sequence. The front panel then enters a wait state while waiting for further power on instructions.

FIG. 4 provides a power on sequence for enclosure servers. The initial power on sequence is performed by the front panel set 410. This is the method that was performed with respect to the method of FIG. 3. Next, a request is received to power on the server processors and servers. The request may be received through the front panel by pressing and holding the power button for a certain of time, such as more than ten seconds. Upon receiving the request, the front panel initiates a power on state to the power supply unit at step 430. The power supply unit then provides power to the enclosure devices at step 440. The power applied at step 440 may be a 12 volt DC power level. The service processor then asserts a chassis ready state to the front panel at step 450. To assert this ready state signal, the service processor receives confirmations from enclosure components that they are powered up and ready to go. The front panel receives the chassis ready state signal at step 460. The front panel then performs a power on for servers at step 470. The service may only be powered on after the drives are powered on within an enclosure.

In some embodiments, one or more service processors may not be available. In this case, the front panel will communicate directly with SAS port expanders rather than with the corresponding service processor.

FIG. 5 is a flowchart of a method for performing a power on sequence for enclosure devices. First, an initial power on sequence is performed by the front panel at step 510. The initial power on sequence may be that discussed above with respect to the method of FIG. 3. Next, the front panel readies the component devices as discussed earlier with respect to the method of FIG. 4. In particular, a request is received to power on the service processors at step 520. The front panel initiates a power on state to a power supply unit at step 530 and the power supply unit provides power to the enclosure devices at step 540. Service processors may then assert a chassis ready state signal to a front panel at step 550. The front panel receives the chassis ready state signal at step 560.

The front panel then maintains a wait state until a request is received to provide power to the servers at step 570. In some embodiments, individual servers may be turned on by selecting a particular server on the front panel, and then providing a selection of the power button.

FIG. 6 provides a method for performing a power down sequence. First, a request is received to perform a shut down by the front panel. The request may be received through one or more front panel buttons or other selectable devices. The front panel then confirms that the service processor status is okay at step 620. If one or more of the service processor confirm a status of not okay, then the front panel may perform the remainder of the steps itself rather than instructing that particular service processor to perform any functions. A request is then sent to the service processors to shut down systems and modules at step 630. A determination is then made as to whether the service processor sends a delay request in response to the shut down request at step 640. For example, a service processor may be performing maintenance, communicating with external devices, or performing some other operation which it needs some time to finish or wrap up before performing a power down. If the service processor does send a delay request, the method of FIG. 6 continues to step 645 where the front panel will wait a period of time before sending another request. If no service processors send a delay request, the service processors will acknowledge the request at step 650 and the service processors perform shut down of components at step 660.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A storage enclosure, comprising:
a single front panel;
a first processor;
a set of hard disks;
a plurality of servers; and
a power supply unit,
the single front panel configured to manage a sequence of power control events using the power supply unit for the plurality of servers, hard disks, and first processor.

2. The storage enclosure of claim 1, wherein the single front panel includes a selection mechanism for selecting each server of the plurality of servers and the first processor.

3. The storage enclosure of claim 1, wherein the single front panel provides status information for each of the plurality of servers and the first processor.

4. The storage enclosure of claim 1, wherein the single front panel may initiate an initial power-on sequence for the first processor and the hard disks in response to a first input.

5. The storage enclosure of claim 1, wherein the single front panel may initiate an initial power-on sequence for the first processor, hard disks, and each of the plurality of servers in response to a first input.

6. The storage enclosure of claim 1, wherein the single front panel may initiate an initial power-on sequence that provides power to the service processor and the hard disks without providing power to any of the plurality of servers.

7. The storage enclosure of claim 1, wherein the single front panel may initiate an initial power-on sequence that provides power to a selected server of the plurality of servers.

8. The storage enclosure of claim 1, wherein the single front panel includes a processor.

9. The storage enclosure of claim 1, wherein the single front panel communicates with the first processor and a set of one or more SAS port expanders in communication with the set of hard disks.

10. The storage enclosure of claim 1, wherein the sequence of power control events is a power-on sequence.

11. The storage enclosure of claim 1, wherein the sequence of power control events is a power-off sequence.

12. A method for managing a power sequence by a front panel of a storage enclosure, the method comprising:
detecting a configuration of the storage enclosure;
receiving input to perform a power-on sequence;
providing a power on signal to a power supply unit;
receiving a chassis ready signal from a first processor, the first processor sending the chassis ready signal in response to receiving ready signals from a plurality of hard drives and port expander units;
providing power to one or more servers within the storage enclosure by the front panel.

13. The method of claim 12, further comprising receiving a second input to provide power to the servers, the power provided to the one or more servers within the storage enclosure by the front panel in response to receiving the second input.

14. A method for managing a power sequence by a front panel of a storage enclosure, the method comprising:
detecting a configuration of the storage enclosure;
receiving input to perform a power-off sequence;
transmitting a shut-down signal by the front panel to each of a plurality of first processors within the storage enclosure;
receiving a ready signal from each of the plurality of first processors;
providing a power off signal to a power supply unit.

15. The method of claim 14, further comprising receiving a delay request from one of the plurality of first processors in response to the shut-down signal.
